(19) United States
(12) Patent Application Publication
(10) Pub. No.: US 2010/0293475 A1
(43) Pub. Date: Nov. 18, 2010

(54) NOTIFICATION OF ADDITIONAL RECIPIENTS OF EMAIL MESSAGES

(75) Inventors: ALASDAIR NOTTINGHAM, WINCHESTER (GB); KEVIN B. SMITH, WINCHESTER (GB); TIMOTHY J. WARD, WINCHESTER (GB)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/772,645

(22) Filed: May 3, 2010

(30) Foreign Application Priority Data
May 12, 2009 (EP) 09159990.2

(51) Int. Cl. G06F 15/16; G06F 3/01

(52) U.S. Cl. 715/752; 709/206

(57) ABSTRACT

An email client software application can include a sending component, a receiving component, a notifier, and a reply-all option. The sending component can be for sending email messages to a set of recipients. The receiving component can be for receiving email messages. The notifier can be for receiving notifications from recipients to whom email messages have been previously sent. The received notifications can indicate that previously sent email messages have been forwarded to others. The reply-all option can be provided such that when triggered it automatically sends a reply message to a subset of recipients associated with an initial one of the email messages and to the others that have been sent the initial one of the email messages. The others included in the subset can be determined from the notifications received and processed by the notifier.

### CROSS-REFERENCE TO RELATED APPLICATIONS

This application claims the benefit of European Patent Application No. 09159990.2 filed 12 May 2009 and entitled “AN APPARATUS, METHOD AND COMPUTER PROGRAM FOR NOTIFICATION OF ADDITIONAL RECIPIENTS OF MESSAGES”, which is assigned to the assignee of the present application, and the teachings of which are hereby incorporated by reference in their entirety.

### BACKGROUND

The disclosure relates to the field of software-based message handling and, more particularly, to automatic notification of additional recipients of email messages.

Electronic mail messages, also known as email messages, are a common use of the Internet. Typically, an email system comprises a server-based email computer program operating on a server computer, that manages the exchange of email messages over one or more networks, and a client-based email computer program operating on a client computer to implement a mail box that receives and holds email messages for a user. Typically, client-based email computer programs also include a graphical user interface (GUI) to enable a user to open and read email messages in addition to creating new email messages.

For the avoidance of doubt, as used herein, an ‘email client’ is to be construed as a client-based email computer program.

Users often send email messages to multiple recipients. Typically, email messages may be forwarded to further recipients, with an option to include additional text. Also, typically, email clients are operable to reply to the sender (‘reply-to’) of an email message, or to reply to the sender and all recipients (‘reply-to-all’) of an email message. However, a problem exists with replying to an email message, as the original sender and the original multiple recipients may not be aware of further recipients of the email message. Indeed, each of the members of the distribution list of an email may have a different view of the membership of the distribution list. Therefore, if a recipient uses ‘reply-to-all’ to reply to an email message, not all recipients of the original email message would necessarily receive the reply. For example, consider an email message sent from User A to User B and User C. User C then sends the email message to User D, without copying User B on the forwarded email message. If User B subsequently uses ‘reply-to-all’ for the original email message then User A (as originator), and User C (as a recipient) will receive the reply. However, User D will not, as User B is unaware that User D received the email message. Prior art does not address the problems that each of the multiple recipients of an email have a different view on the distribution list.

### BRIEF SUMMARY

Numerous aspects of the disclosure are contemplated which can be optionally implemented in various embodiments of the disclosure. Not all aspects are present in every embodiment, and described aspects are expected to be tailored and adapted for specific implementations. Thus, the various aspects and details expressed herein, when taken as a whole, permit one of ordinary skill in the art to grasp the scope of the present disclosure, which is defined more succinctly by the claims. It should be understood that nothing in this brief summary or detailed description is meant to be construed in a manner that limits the scope of the claimed content expressed herein.

One aspect of the disclosure is for a method, computer program product, system, and apparatus for providing notification to email clients with recipient updates resulting from email forwards. In the aspect, an initial email message can be sent to a set of recipients. A notification message can be received from a first one of the recipients responsive to the first one forwarding the initial email message to an additional recipient. The notification message can indicate that the first one has forwarded the email message to at least one additional recipient. Responsive to receipt of the notification message, an update message can be composed. The update message can indicate that the first one of the recipients has forwarded the message to the additional recipient. The update message can be sent to at least one of the set of recipients other than the first one.

Another aspect of the disclosure can be for an email client software application. The application can include a sending component, a receiving component, a notifier, and a reply-all option. The sending component can be for sending email messages to a set of recipients. The receiving component can be for receiving email messages. The notifier can be for receiving notifications from recipients to whom email messages have been previously sent. The received notifications can indicate that previously sent email messages have been forwarded to others. The reply-all option can be provided such that when triggered it automatically sends a reply message to a subset of recipients associated with an initial one of the email messages and to the others that have been sent the initial one of the email messages. The others included in the subset can be determined from the notifications received and processed by the notifier.

### BRIEF DESCRIPTION OF THE SEVERAL VIEWS OF THE DRAWINGS

FIG. 1 is a block diagram depicting a data processing system, in which the present invention may be embodied, in accordance with an embodiment of the present invention.

FIG. 2 is a diagram depicting a screen shot from a simplified email client in which the present invention may be embodied, in accordance with an embodiment of the present invention.

FIG. 3 (Prior Art) is a block diagram depicting an email client according to the prior art.

FIG. 4 is a block diagram depicting messages operating in an email system in which the present invention may be embodied, in accordance with an embodiment of the present invention.

FIG. 5 is a block diagram depicting a modified email client in accordance with an embodiment of the present invention.

FIG. 6 is a high-level exemplary schematic flow diagram depicting typical operation method steps performed to update a distribution list of an email message in accordance with an embodiment of the present invention.

### DETAILED DESCRIPTION

The disclosure provides a solution for updating a client to allow the originator of a message to send updated message information concerning a previously sent message. The updated message information concerns the membership of the distribution list of the message. The originator has the option to send an update to the original message. In one embodiment, updated email message information contains information relating to the original email message and the distribution list changes that have been made to it. For example, the Multipurpose Internet Mail Extensions (MIME) capabilities of the email message can be used when updating the distribution list.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

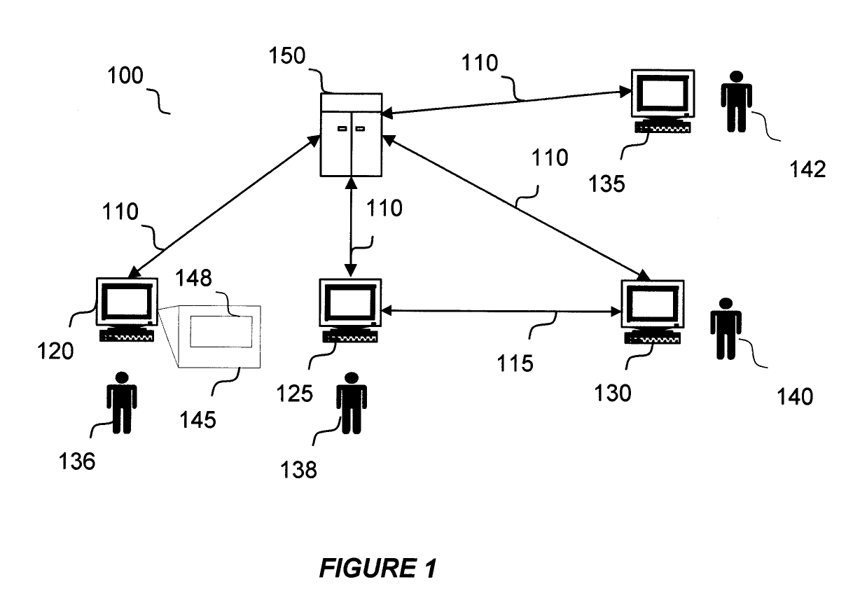

Referring now to FIG. 1, FIG. 1 is a block diagram depicting a data processing system 100, in accordance with an embodiment of the present invention. An email system (not depicted) is used on a data processing system 100 that comprises workstation A 120, workstation B 125, workstation C 130, work station D 135 and a server 150. Workstations 120, 125, 130, 135 and server 150 are connectable through a data processing network 110. The workstations may also be connectable through a peer to peer (P2P) connection 115. An email client 145 is operated on the workstations 120, 125, 130, 135 in communication with an email server (not depicted) operated on the server 150, and with each other. Only the email client 145 on workstation A 120 is depicted. An email message 148 is depicted on email client 145. FIG. 1 depicts User A 136, User B 138, User C 140, and User D 142. Users access the email system by interacting with an email client operating on a workstation 120, 125, 130, 135. For example, User A 136 accesses the email system by interacting with the email client 145 operating on workstation A 120. For the avoidance of doubt, as used herein, email message interactions designated in the invention description between User A 136, User B 138, User C 140 and User D 142 are performed by email clients that User A 136, User B 138, User C 140 and User D 142 respectively interact with.

By way of description, as an example, User A 136 is the sender of an email message 148 to User B 138 and User C 140. Following receipt of the email message 148, User C 140 forwards the email message 148 to User D 142 in a second email message, without adding User B 138 to the distribution list of the second email message.

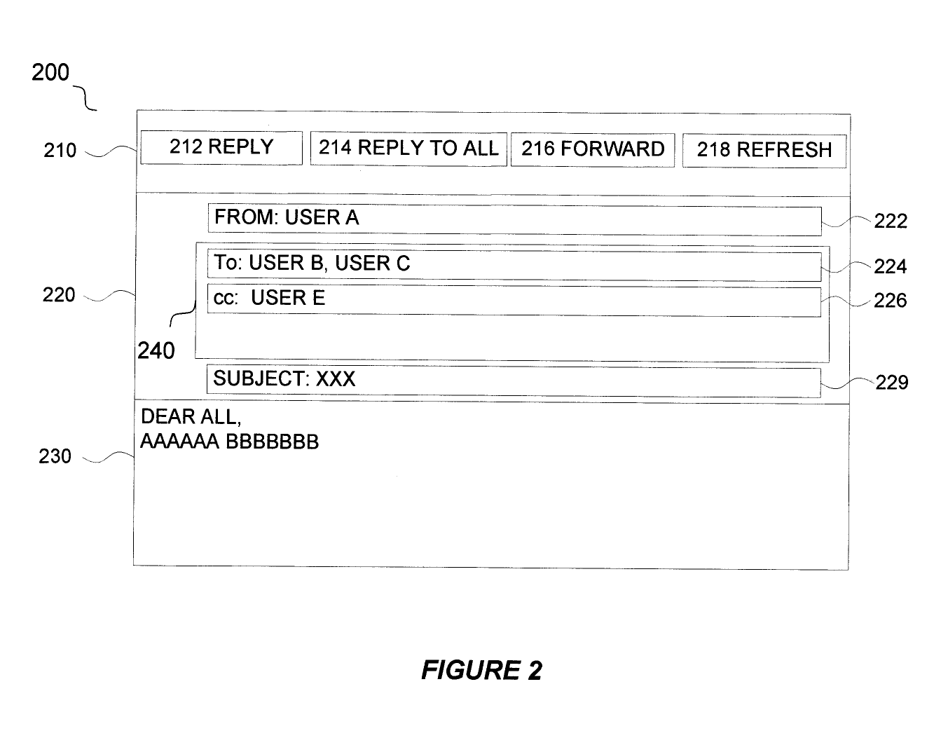

FIG. 2 is a diagram depicting an exemplary view 200 from a simplified email client 145, in accordance with an embodiment of the present invention. The view 200 depicts an email message 148 as viewed by the sender User A 136, including a header section 220 and a body section 230. The header section indicates that this email message 148 was previously sent (‘To’ field 222) to two recipients (User B and User C), and carbon copied (‘cc’ field 224) to User E. Subject section 229 indicates the subject of the email message 148. The distribution list 240 of the email message 148 comprises fields 222, 224 and 226. The graphical user interface (GUI) of the email client 145 provides a field 210 for displaying functions 212, 214, 216, 218. The functions comprise: a reply button 212 for replying to the sender; a reply-to-all button 214 for replying to all; a forward button 216 for forwarding the email message 148 to a further recipient; and a refresh button 218 for updating the email message 148 to include additional recipients' information. The body section 230 comprises the text of the email message 148.

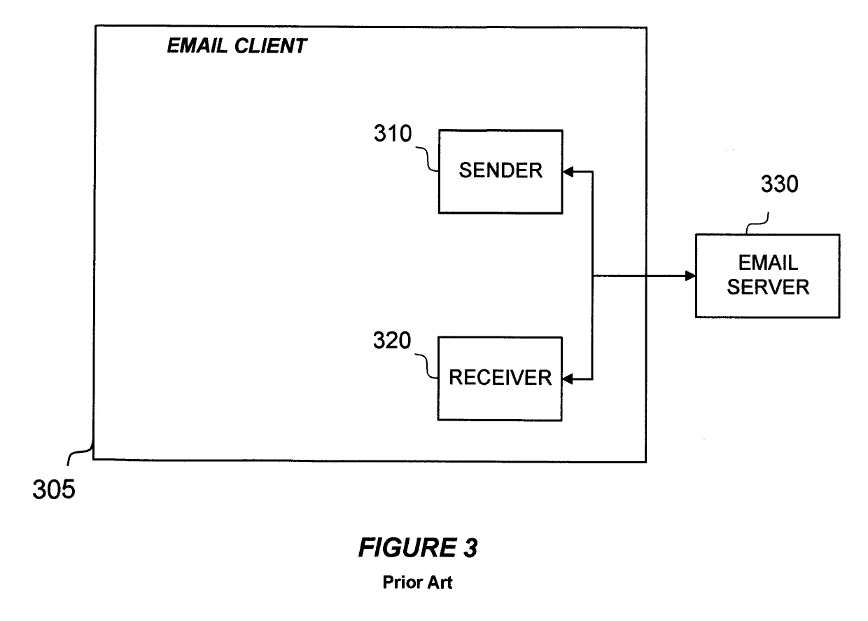

FIG. 3 (Prior Art) is a block diagram depicting an email client 305 according to the prior art. The email client 305 comprises a sender component 310 for sending an email message 148, and a receiver component 320 for receiving an email message 148. Typically, the email client 305 is connectable with an email server 330.

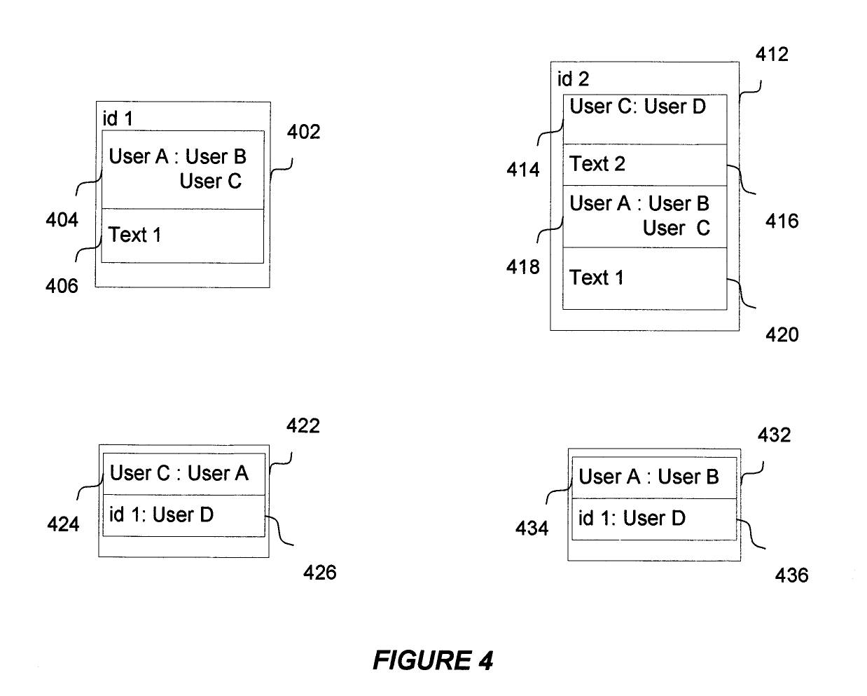

FIG. 4 is a block diagram depicting messages operating in an email system, in accordance with an embodiment of the present invention. A first email message 148, 402 comprises a header section 220, 404 and a body section 406. The email message 148, 402 is identified as ‘id 1’. The header section 404 designates that the sender is User A 136, and that User B 138 and User C 140 are in the distribution list 240 of the email message 148, 402. The body section 406 comprises text ‘Text 1’ of the email message 148, 402. A second email message 148, 412 comprises the first email message 148, 402 forwarded to a further recipient User D 142 by User C 140. The second email message 148, 412 is identified as ‘id 2’. The header section 414 designates that the sender is User C 140, and that User D 142 is in the distribution list 240. The body section 416 of the second email message 148, 412 comprises text ‘Text 2’. The contents of the first email message 148, 402 is included in sections 418 and 420.

A notification message 422 is generated by User C 140, in response to User C 140 forwarding an email message 148, 402 to User D 142. The notification message 422 is sent to inform User A 136, as the originator of the email 148, 402, that User C 140 has forwarded the email message 148, 402. A typical notification message 422 comprises: a header section 424 depicting that User C 140 sends the notification message 422 to User A 136; and a body section 426 depicting information, for example, that User D 142 has been added to the distribution list 240 of email message 148, 402 ‘id 1’. User A 136 uses such information in the notification message 422 to match the notification message 422 to the original email 148, 402.

An update message 432 is composed by User A 136 in response to receiving a notification message 422. The update message 432 is sent by User A 136 to User B 138. The update message 432 informs User B 138 that the email message 148, 402 has been forwarded to User D 142. A typical update message 432 comprises: a header section 434 depicting that User A 136 sends the update message 432 to User B 138; and a body section 436 depicting that User D 142 has been added to the distribution list 240 of email message 148, 402 ‘id 1’.

Thus, the original email user (User A) is continuously kept informed of all recipients that have received (been forwarded) a message by others (such as user D). User A can then send each other user an update (message 432) so all users on an email thread are aware of which users (including User D) have received the original email. This arrangement ensues that all email users have an option to “reply to all” and ensure that everyone involved in an email discussion (a thread) will receive the reply.

Security and privacy considerations can be added to the scenario described by FIG. 4, in one embodiment, to ensure that some user identities can remain private. For example, User A can be made aware that forwards of a message have been conducted (via message 422, for example), while not providing exact addresses (e.g., the email address and identify of User D can remain anonymous). When “reply to alls” occur, an indicator can be sent from User A <or a replying user> to the email client of User C, where an auto-forward from User C to User D can occur—again retaining the privacy of User D's identity. An email server (as opposed to an email client of User C) can perform the forwarding actions to User D as appropriate in one embodiment.

Other configurations may be realized by a person skilled in the art without departing from the scope of the invention.

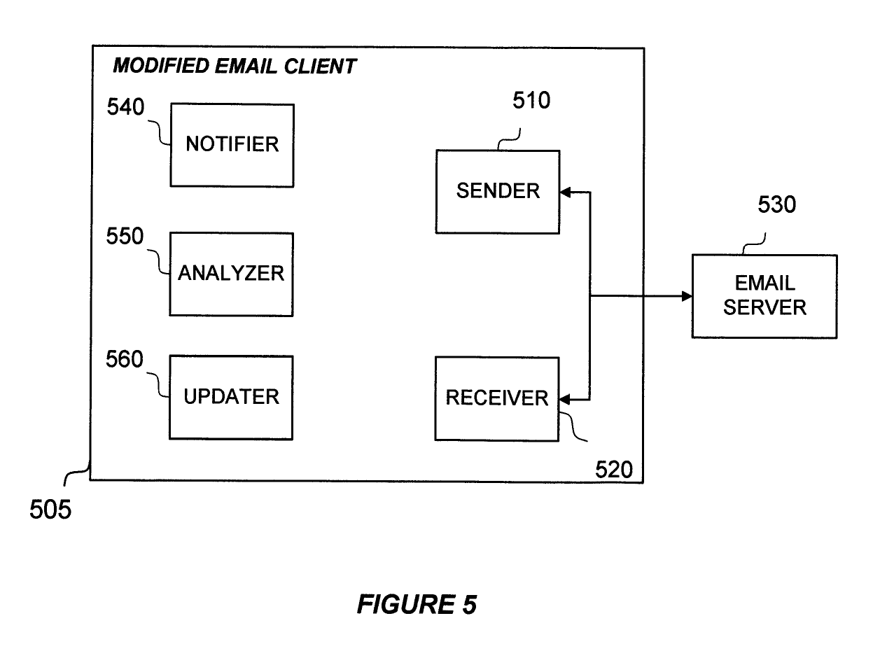

FIG. 5 is a block diagram depicting a modified email client 505 in accordance with an embodiment of the present invention. The modified email client 505 comprises a sender component 310, 510 for: sending an email message 148; sending a notification message 422; or sending an update message 432. The modified email client 505 further comprises a receiver component 320, 520 for: receiving an email message 148; receiving a notification message 422; or receiving an update message 432. Typically, the modified email client 505 is connectable with an email server 330, 530. The modified email client 505 further comprises: a notifier component 540 for generating a notification message 422; and an updater component 560 for composing an update message 432. The modified email client 505 further comprises an analyzer component 550 for: analyzing a received notification message 422; or analyzing an update message 432 for new recipients. Those skilled in the art will appreciate that such an apparatus can be implemented by a number of component variations, and that multiple components may be operable for one or multiple operations associated with the invention.

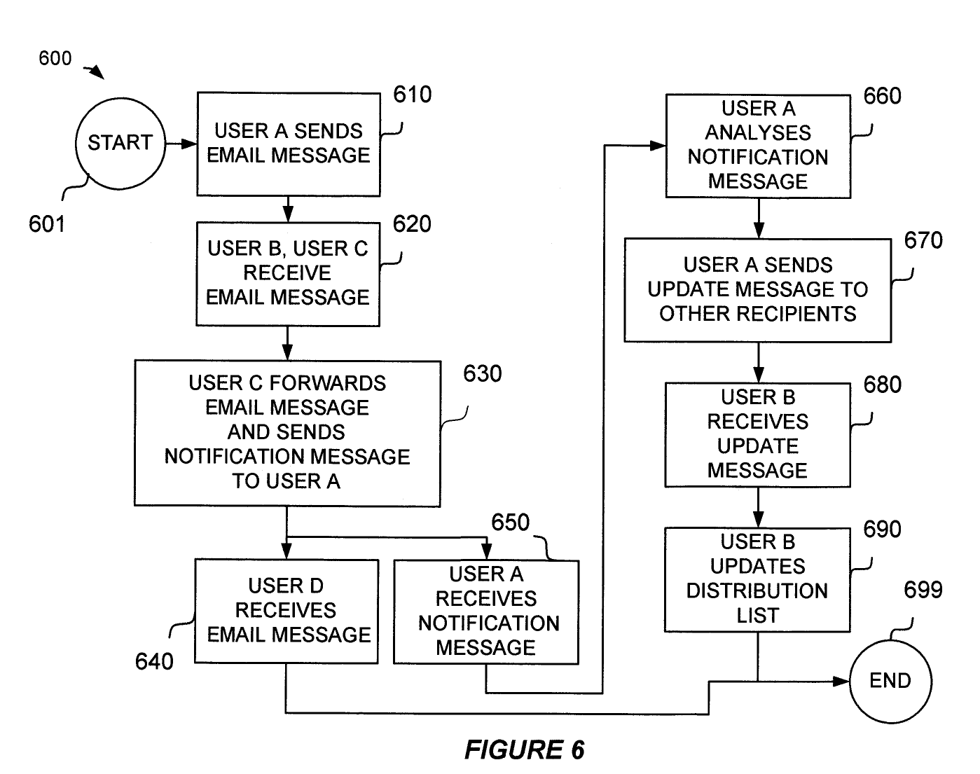

FIG. 6, which should be read in conjunction with FIGS. 4 and 5, is a high-level exemplary schematic flow diagram 600 depicting typical operation method steps performed to update a distribution list 240 of an email message 148 in accordance with a preferred embodiment of the present invention. FIG. 6 is set forth as a logical flow chart diagram. As such, the depicted order and labeled steps are indicative of one embodiment of the presented method. Other steps and methods may be conceived that are equivalent in function, logic, or effect of one or more steps or portions thereof, of the illustrated method. Additionally the format and symbols employed are provided to explain the logical steps of the method and are understood not to limit the scope of the method.

The method starts at step 601. At step 610, a sender component 310, 510 of User A 136 sends email message ‘id 1’ 148, 402 to User B 138, and to User C 140. At step 620, receiver components 320, 520 of User B 138 and User C 620 receive the email message ‘id 1’ 148, 402. At step 630, the sender component 310, 510 of User C 140 forwards email message ‘id 1’ 148, 402 to User D 142 in email message ‘id 2’ 148, 412. Email message ‘id 2’ 148, 412 may comprise text ‘Text 2’. Also, at step 630, a notifier component 540 of User C 138 composes a notification message 422. The sender 310, 510 of User C 138 sends the notification message 422 to the originator User A 136 of email message ‘id 1’ 148, 402 to inform User A 136 that User C 138 has forwarded the email message 148, 402 ‘id 1’ to User D 142. At step 640, the receiver component of User D 142 receives the email message ‘id 2’ 148 412.

At step 650, the receiver component of User A 136 receives the notification message 422. At step 660, the analyzer component of User A 136 matches the notification message 422 with the original email message 148, 402, and then analyses the received notification message 422 for new recipient User D 142. User A 136 updates its records of email message 148, 402 by updating the distribution list 240 of email message 148, 402. The analysis may also comprise a determination of recipient relationships, for example, which recipients are aware of which other recipients. The determined relationships may be stored in a distribution table (not shown) for the email message 402. For example, in the example used, at step 630, both User C 138 and User D 142 are aware that User A 136, User B 138, User C 140, and User D 140 are on distribution of the email message ‘id 1’ 148, 402. However, if User B 138 is not on the distribution list 240 of email message ‘id 2’ 148, 412, User B 138 is only aware that User A 136, User B 138, and User C 140 are on distribution list 240 of email message ‘id 1’ 148, 402.

At step 670, an updater component 560 of User A 136 composes an update message 432 comprising information concerning email message ‘id 1’ 148, 402. The sender component 310, 510 of User A 136 sends the update message 432 to User B 138. At step 680, the receiver component 320, 520 of User B 138 receives the update message 432. At step 690, the analyzer component 550 of User B 138 matches the update message 432 with the original email message ‘id 1’ 148, 402, and then analyses the update message 432 for new recipient User D 142. User B 138 updates its records of email message ‘id 1’ 148, 402 by updating the distribution list 240 of email message 148, 402. Consequently, all users are aware of all other users on the distribution list 240 of email message ‘id 1’ 148, 402. The method ends at step 699.

In an alternative embodiment, the analyzer of User A 136 does not analyze the notification message 422 for new recipients. Instead, the update message 432 may be sent to all members in the distribution list 240. On receipt of the update message 432, all the members match the update message 432 with the original email message ‘id 1’ 148, 402, analyzing the update message for new recipients. This alternative embodiment uses less effort for User A 136, but more effort for the other members of the distribution list 240.

In one embodiment, a copy of an email message 148, 202 held by User B 138 is updated on receipt of the update message 432. In an alternative embodiment, the modified email client 145, 505 of User B 138 is updated, so that on opening an email message 148, 402 a check is performed to identify any updates that have been received. In this case, the distribution list 240 of the email message ‘id 1’ 148, 402 is updated automatically. In an alternative embodiment, on opening an email message 148, 402, a refresh button 218 is made available, as depicted in FIG. 2. The refresh button 218 signifies to User B 138 that the distribution list 240 has changed. The refresh button 218 is operable to refresh the distribution list 240 of the email message ‘id 1’ 148, 402.

In an alternative embodiment, when User B 138 operates a reply-to-all function, a dialogue box appears that provides User B 138 with an option to include any or all of the enlarged distribution list 240. In an alternative embodiment, on receiving a distribution list 240 for an email message ‘id 1’ 148, 402 the modified email client 505 of User B 138, automatically forwards a corresponding ‘reply-to-all’ email message already sent by User B 138, to any new members of the distribution list 240 of email message ‘id 1’ 148, 402. In an alternative embodiment, on receiving a updated distribution list 240 for an email message ‘id 1’ 148, 402 the modified email client 505 of User B 138 alerts User B 138, and provides an option to forward a corresponding ‘reply-to-all’ email message already sent, to new members of the distribution list 240.

In one embodiment, notification message 422 and update message 432 comprise MIME encoded header information providing details of an updated distribution list 240. The MIME encoded header information is designated as an update type and contain information on the header 220 of the email message 148, 402 that was sent. The information may contain information about, for example, the subject, date and time to enable full identification of the email message 149, 402 by the receiving modified email client 505 of User B 138. The modified email client 505 of User B 138 may recognize the update encoding in the email and be able to process the header information included to identify the original email. The modified email client 505 of User B 138 may determine the difference between the distribution list 240 provided in the update message 432 and the distribution list 240 in the original email message 148, 402. In an alternative embodiment, the modified email client 505 of User A 138 determines the difference between the distribution list 240 provided in the notification message 422 and the distribution list 240 in the original email message 148, 402, providing the difference in the update message 432 to User B 138.

In an alternative embodiment, update message 432 comprises an updated distribution list 240 and the original email message ‘id 1’ 148, 402. The update message 432 replaces the original email message ‘id 1’ 148, 402 at the email client 305, 505 of User B 138. Updated email message information can be compatible with prior art email clients 305. Prior art email clients 305 that may not support the update function accept the email message ‘id 1’ 148, 402 as a new email message 148 (not depicted), for example ‘id 3’.

In one embodiment, automatic notification of additional recipients of an email message 148, 402, as described herein, is provided as an option of an email message 148, 402. The option may be taken by the originator User A 136 when the email message 148, 402 is sent (step 610), or alternatively, when the notification message 422 is analyzed (step 660).

It should be appreciated that the flow of FIG. 6 shows an email client centric approach, where notifications (e.g., step 650, 680) are conveyed to email clients that permit each email client to be aware of a current list of email recipients who have received an email communication (often due to the communication being forwarded by another. In one contemplated embodiment, the notification messages need not be explicitly sent and tracked by email clients, but instead an email server (e.g., server 530) can maintain records of the set of email recipients. Thus, when forwards and replies to all occur, the email server (server 530) can determine an appropriate set of recipients by consulting its internal database (which is updated whenever a “notification” would have been sent to clients—per step 650, 680). A hybrid approach can be implemented, where server-side updates occur when possible (when supported by an email server), and otherwise functionality can be implemented by an email client (when the email server does not support email conveyance tracking as detailed herein). Thus, the functionality of the disclosure can be implemented in either a server, a client, or both—which permits maximum compatibility with legacy (non-upgraded components lacking email conveyance tracking capabilities, as described herein) clients and servers.

For the avoidance of doubt, the term “comprising”, as used herein throughout the description and claims is not to be construed as meaning “consisting only of”. It will be appreciated by those skilled in the art that the invention is not just limited to email messages, but is also applicable to other types of messages that have a distribution list that can be updated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing notification to email clients with recipient updates resulting from email forwards comprising:
sending an initial email message to a plurality of recipients;
receiving a notification message from a first one of the recipients responsive to the first one forwarding the initial email message to an additional recipient, wherein the notification message indicates that the first one has forwarded the email message to at least one additional recipient;
responsive to receipt of the notification message, composing an update message, wherein the update message indicates that the first one has forwarded the message to the additional recipient; and
sending the update message to at least one of the plurality of recipients other than the first one.

2. The method of claim 1, wherein the sending further comprises:
sending the update message to each other plurality of recipients other than the first one.

3. The method of claim 1, wherein the sending of initial email message, the receiving of the notification message, the composing of the update message, and the sending of the update message are performed by software of an email client being executed by a processor.

4. The method of claim 1, wherein the receiving of the notification message, the composing of the update message, and the sending of the update message occur automatically without any manual interactions being performed by the originator of the initial email message or by any of the recipients.

5. The method of claim 1, wherein the method further comprises:
updating a record of the initial email message maintained by an email client that sent the initial email message to indicate that the additional recipient received the initial email message.

6. The method of claim 5, further comprising:
showing the initial email message within a graphical user interface of the email client after the record of the initial email message has been updated, wherein when showing the initial email message within the graphical user interface and visual indicator is presented that indicates the additional recipient has received the initial email message.

7. The method of claim 1, wherein the method further comprises:
responsive to at least a second email client receiving the sent update message, the second email client updating a record of the initial email message maintained by the second email client to indicate that the additional recipient received the initial email message.

8. The method of claim 1, further comprising:
after receiving the notification message, an email client that sent the initial message receiving a user command to reply-to-all recipients of the initial email message, wherein the reply-to-all corresponds to a follow-up email message; and
responsive to receiving the user command, the email client sending the follow-up email message to each of the plurality of recipients and to the additional recipient.

9. The method of claim 1, further comprising:
after receiving the update message, an email client that received the initial message but that is not the first one of the recipients receiving a user command to reply-to-all recipients of the initial email message, wherein the reply-to-all corresponds to a follow-up email message; and
responsive to receiving the user command, the email client sending the follow-up email message to each of the plurality of recipients other than itself, to the sender of the initial email message, and to the additional recipient.

10. The method of claim 1, wherein the notification message and the update message are email messages.

11. The method of claim 10, wherein the email client that sent the initial email message is enhanced to identify the notification message and to treat it differently than standard email message, wherein the notification message is not displayed to a user within a user interface of the email client but instead triggers the email client to perform the composing and sending automatically without manual user input being received for performing the composing and sending.

12. A computer program product comprising a computer readable storage medium having computer usable program code embodied therewith, the computer usable program code comprising:
computer usable program code stored on a tangible storage medium that when executed by a processor is operable to send an initial email message to a plurality of recipients;
computer usable program code stored on a tangible storage medium that when executed by a processor is operable to receive a notification message from a first one of the recipients responsive to the first one forwarding the initial email message to an additional recipient, wherein the notification message indicates that the first one has forwarded the email message to at least one additional recipient;
computer usable program code stored on a tangible storage medium that when executed by a processor is operable to, responsive to receipt of the notification message, compose an update message, wherein the update message indicates that the first one has forwarded the message to the additional recipient; and
computer usable program code stored on a tangible storage medium that when executed by a processor is operable to send the update message to at least one of the plurality of recipients other than the first one.

13. The computer program product of claim 12, further comprising:
computer usable program code stored on a tangible storage medium that when executed by a processor is operable to update a record of the initial email message maintained by an email client that sent the initial email message to indicate that the additional recipient received the initial email message.

14. The computer program product of claim 12, further comprising:
computer usable program code stored on a tangible storage medium that when executed by a processor is operable to show the initial email message within a graphical user interface of the email client after the record of the initial email message has been updated, wherein when showing the initial email message within the graphical user interface a visual indicator is presented that indicates the additional recipient has received the initial email message.

15. The computer program product of claim 12, further comprising:
computer usable program code stored on a tangible storage medium that when executed by a processor is operable to, responsive to at least a second email client receiving the sent update message, cause the second email client to update a record of the initial email message maintained by the second email client to indicate that the additional recipient received the initial email message.

16. An email client software application executable by a processor of the apparatus, wherein the email client software application is stored on a tangible storage medium, the apparatus comprising:
a sending component for sending email messages to a plurality of recipients;
a receiving component for receiving email messages;
a notifier for receiving notifications from recipients to whom email messages have been previously sent, said received notifications indicating that previously sent email messages have been forwarded to others; and
a reply-all option of the email client, wherein when triggered automatically sends a reply message to a subset of recipients associated with an initial one of the email messages and to the others that have been sent the initial one of the email messages as determined from the notifications received and processed by the notifier.

17. The email client of claim 16, wherein in absence of the notifications, the email client would be unaware of the others and would not be able to send the others the reply message responsive a triggering of the reply-all option.

18. The email client of claim 16, further comprising:
an updater for sending updates to a subset of the recipients to inform each of the subset of recipients of the others responsive to the notifier receiving and processing notifications regarding email messages, wherein the subset includes a set of recipients that received one of the previously sent email messages.

19. The email client of claim 16, further comprising:
a history log for maintaining records of sent and received email messages;
wherein a list of recipients that received email messages as maintained in the records is updated responsive to the notifier processing the notifications.

20. The email client of claim 16, further comprising:
a graphical user interface comprising a visually displayed section showing previously sent email messages, wherein showing previously sent email messages for which the notifier has received at least one notification for others, the graphical user interface shows a visual indicator proximate to the corresponding sent email message that indicates the others have received the corresponding sent email.
